(19) United States
(12) Patent Application Publication
(10) Pub. No.: US 2026/0079013 A1
(43) Pub. Date: Mar. 19, 2026

(54) SYSTEM AND METHOD FOR AUTOMATICALLY TRANSMITTING ALERT MESSAGES BASED ON TIME AND LOCATION MONITORING IN VEHICLE JOURNEY SUPERVISION

(71) Applicant: Saudi Arabian Oil Company, Dhahran (SA)

(72) Inventors: Rami A. Al-Ghanim, Dhahran (SA); Abdullah Y. Al-Hassan, Hasa (SA); Ali S. Al-Habbas, Dhahran (SA); Shayem F. Al-Enezi, Khafji (SA)

(73) Assignee: Saudi Arabian Oil Company, Dhahran (SA)

(21) Appl. No.: 18/890,503

(22) Filed: Sep. 19, 2024

(51) Int. Cl. G01C 21/34; H04W 4/029; H04W 4/90

(52) U.S. Cl. CPC G01C 21/3407; H04W 4/029; H04W 4/90

(57) ABSTRACT

System and method adapted to: obtain a plurality of parameters for a planned journey of a vehicle associated with a computing device; determine, based on the plurality of parameters, whether the planned journey includes at least one special condition; when the planned journey includes at least one special condition, activating journey monitoring; the journey monitoring including: obtaining a location of the vehicle; comparing the obtained location to an expected location; when the obtained location exceeds a predetermined distance from the expected location, determining, in an iterative or recursive manner, whether an updated arrival time has been received from the computing device or the vehicle, when the updated arrival time has not been received after a predetermined time period, transmitting an alert to another computing device associated with an operator; and transmitting a request for emergency services when an iteration count for the determining is exceeded.

### FIELD OF THE DISCLOSURE

The present disclosure generally relates to an automatic vehicle journey supervision system and, more specifically, to a system and method adapted to automatically transmit alert messages based on time and location monitoring in vehicle journey supervision.

### BACKGROUND OF THE DISCLOSURE

Existing fleet management systems provide for passive tracking of vehicles, as well as access authorization and controls. However, there have heretofore not been a fully automated vehicle journey management system. For tracking and monitoring fleets of work vehicles on specified routes and trips, disparate, and often incompatible, systems need to be integrated and can require active operator engagement for providing accurate and up to date information. Such programs are often cumbersome and fail to provide vital information especially in cases of search and rescue. For example, conventional work vehicle management systems are incapable of providing timely alerts on possible emergency situations, especially in or near remote hazardous regions or where an operator is incapable of initiating such alerts, to expediate search and rescue.

### SUMMARY OF THE DISCLOSURE

In view of the shortcomings in the field of work vehicle tracking and management, the present disclosure provides a technological improvement to fully automated vehicle journey management systems by integrating automated periodic operator prompts for journey tracking and updates to ensure operator safety and to initiate timely alerts when emergencies arise.

According to one or more example implementations consistent with the present disclosure, a system, comprises: one or more processing devices; a communications interface; a non-transitory computer-readable memory operatively connected to the one or more processing devices and having stored thereon machine-readable instructions that, when executed, cause the one or more processing devices to: obtain, via the communications interface from a computing device, a plurality of parameters for a planned journey of a vehicle associated with the computing device; determine, based on the plurality of parameters, whether the planned journey includes at least one special condition; in response to determining that the planned journey includes at least one special condition, activate journey monitoring upon initiating the planned journey; in response to determining that the planned journey does not include at least one special condition, initiate the planned journey without activating the journey monitoring; wherein the journey monitoring comprises: obtaining, via the communications interface, a location of the vehicle; comparing the obtained location of the vehicle to an expected location based on an expected progress of the initiated journey; in response to the comparing indicating that the obtained location of the vehicle exceeds a predetermined distance from the expected location, determine, in an iterative or recursive manner, whether an updated arrival time has been received from one or more of the computing device and the vehicle via the communications interface, said determination comprising: in response to determining that the updated arrival time has been received, registering the received updated arrival time in association with the initiated journey and terminating said determining for the updated arrival time; in response to determining that the updated arrival time has not been received after a predetermined time period, transmitting an alert to another computing device associated with an operator on a next level in a hierarchy associated with the initiated journey; and incrementing an iteration counter for a next iteration until the iteration counter exceeds a predetermined iteration number; and in response to the iteration counter exceeding the predetermined iteration number, transmitting a request for emergency services, said request comprising location information from a plurality of sources selected from the group consisting of: a global positioning system (GPS) location associated with the vehicle, a GPS location associated with the computing device, a location associated with the vehicle determined based on one or more terrestrial networks, a location associated with the computing device determined based on one or more terrestrial networks.

In one or more example implementations, the predetermined distance is about 1 kilometer (km) to about 2 km, the predetermined time period is about 1 hour, and the predetermined iteration number is 2.

In one or more example implementations, the one or more special conditions are selected from the group consisting of: nighttime driving, travel and activity that exceeds 24 hours, travel that crosses a national border, travel outside of safe zones, travel off road, travel in an area lacking terrestrial network coverage, and travel outside of at least one coverage area of a location determination service.

In one or more example implementations, the system further comprises additional machine-readable instructions stored on the non-transitory computer-readable memory that, when executed, cause the one or more processing devices to: in response to the comparing indicating that the obtained location of the vehicle exceeds a predetermined distance from the expected location and prior to said determining for the updated arrival time, transmit a notification to the computing device, said notification comprising a prompt for a user to request the emergency services.

In one or more example implementations, the notification further comprises a prompt for a user input for the updated arrival time.

In one or more example implementations, the journey monitoring further comprises: determining whether the obtained location of the vehicle is within a predetermined proximity of a destination of the initiated journey, wherein the journey monitoring is executed in an iterative or recursive manner until the obtained location of the vehicle is determined to be within the predetermined proximity of the destination of the initiated journey, and wherein the journey monitoring is terminated upon receiving, via the communications interface, an arrival confirmation from at least one of the computing device and the vehicle.

In one or more example implementations, the journey monitoring further comprises: receiving, via the communications interface, a communication from a subsystem of the vehicle indicating damage or malfunction in connection with the vehicle, wherein the transmitting of the alert to another computing device is executed in response to receiving the communication from the subsystem of the vehicle.

In one or more example implementations, the transmitting of the request for emergency services is executed in response to receiving the communication from the subsystem of the vehicle.

In one or more example implementations, the parameters comprise a starting point of the planned journey, a destination of the planned journey, a start time of the planned journey, and an identifier for the vehicle.

According to one or more example implementations consistent with the present disclosure, a method, comprises: obtaining, via a communications interface from a computing device, a plurality of parameters for a planned journey of a vehicle associated with the computing device; determining, based on the plurality of parameters, whether the planned journey includes at least one special condition; when it is determined that the planned journey includes at least one special condition, activating journey monitoring upon initiating the planned journey; when it is determined that the planned journey does not include at least one special condition, initiating the planned journey without activating the journey monitoring; wherein the journey monitoring comprises: obtaining, via the communications interface, a location of the vehicle; comparing the obtained location of the vehicle to an expected location based on an expected progress of the initiated journey; when the comparing indicates that the obtained location of the vehicle exceeds a predetermined distance from the expected location, determine, in an iterative or recursive manner, whether an updated arrival time has been received from one or more of the computing device and the vehicle via the communications interface, said determination comprising: when it is determined that the updated arrival time has been received, registering the received updated arrival time in association with the initiated journey and terminating said determining for the updated arrival time; when it is determined that the updated arrival time has not been received after a predetermined time period, transmitting an alert to another computing device associated with an operator on a next level in a hierarchy associated with the initiated journey; and incrementing an iteration counter for a next iteration until the iteration counter exceeds a predetermined iteration number; and when the iteration counter exceeds the predetermined iteration number, transmitting a request for emergency services, said request comprising location information from a plurality of sources selected from the group consisting of: a global positioning system (GPS) location associated with the vehicle, a GPS location associated with the computing device, a location associated with the vehicle determined based on one or more terrestrial networks, a location associated with the computing device determined based on one or more terrestrial networks.

In one or more example implementations, the predetermined distance is about 1 kilometer (km) to about 2 km, the predetermined time period is about 1 hour, and the predetermined iteration number is 2.

In one or more example implementations, the one or more special conditions are selected from the group consisting of: nighttime driving, travel and activity that exceeds 24 hours, travel that crosses a national border, travel outside of safe zones, travel off road, travel in an area lacking terrestrial network coverage, and travel outside of at least one coverage area of a location determination service.

In one or more example implementations, the method further comprises: when the comparing indicates that the obtained location of the vehicle exceeds a predetermined distance from the expected location and prior to said determining for the updated arrival time, transmitting a notification to the computing device, said notification comprising a prompt for a user to request the emergency services.

In one or more example implementations, the notification further comprises a prompt for a user input for the updated arrival time.

In one or more example implementations, the journey monitoring further comprises: determining whether the obtained location of the vehicle is within a predetermined proximity of a destination of the initiated journey, wherein the journey monitoring is executed in an iterative or recursive manner until the obtained location of the vehicle is determined to be within the predetermined proximity of the destination of the initiated journey, and wherein the journey monitoring is terminated upon receiving, via the communications interface, an arrival confirmation from at least one of the computing device and the vehicle.

In one or more example implementations, the journey monitoring further comprises: receiving, via the communications interface, a communication from a subsystem of the vehicle indicating damage or malfunction in connection with the vehicle, wherein the transmitting of the alert to another computing device is executed in response to receiving the communication from the subsystem of the vehicle.

In one or more example implementations, the transmitting of the request for emergency services is executed in response to receiving the communication from the subsystem of the vehicle.

In one or more example implementations, the parameters comprise a starting point of the planned journey, a destination of the planned journey, a start time of the planned journey, and an identifier for the vehicle.

### BRIEF DESCRIPTION OF THE DRAWING FIGURES

Various example implementations of this disclosure will be described in detail, with reference to the following figures, wherein:

FIG. 1 is a schematic illustration of an automated vehicle journey tracking and management system according to one or more exemplary implementations of the present disclosure.

FIG. 2 is a flow diagram showing a vehicle journey planning and approval process executed using the system of FIG. 1 according to one or more exemplary implementations of the present disclosure.

FIGS. 3A, 3B, and 3C are diagrams illustrating respective graphical user interface (GUI) screens for inputting journey parameters to the computing apparatus of FIG. 1 in correspondence with a process step of FIG. 2 according to one or more exemplary implementations of the present disclosure.

FIGS. 4A and 4B are diagrams illustrating respective GUI screens for functionality at the vehicle(s) and/or computing device(s) of FIG. 1 for an active journey according to one or more exemplary implementations of the present disclosure.

FIG. 5 is a flow diagram showing a vehicle journey tracking and alert generating process executed using the system of FIG. 1 according to one or more exemplary implementations of the present disclosure.

FIG. 6 is a schematic diagram showing exemplary computing apparatuses and computing devices that can be used to implement the techniques of the present disclosure.

### DETAILED DESCRIPTION OF CERTAIN EMBODIMENTS OF THE DISCLOSURE

The present disclosure relates to a vehicle journey management system that incorporates triplex layered geofencing into a geographic information system mapping platform. Advantageously, the triplex layered geofencing enables accurate tracking of work vehicles on their respective journeys and provides for automatically escalating alerts for periodic delays in operator updates during active journeys. Such alert escalations include transmitting requests to emergency services and allowing emergency responders to instantly locate stranded individuals via both mobile and vehicle Global Positioning System (GPS) coordinates, as well as detecting any deviations of planned trip routes. In certain embodiments, the operation of the vehicles are directly communicated from vehicle subsystems via various communication platforms, including without limitation, mobile networks such as the Global System for Mobile Communications (GSM), text messaging systems, automatic vehicle locators, radio systems, emergency response services such as the Community Emergency Response Team (CERT) and SafeLine™, and email networks, to name a few.

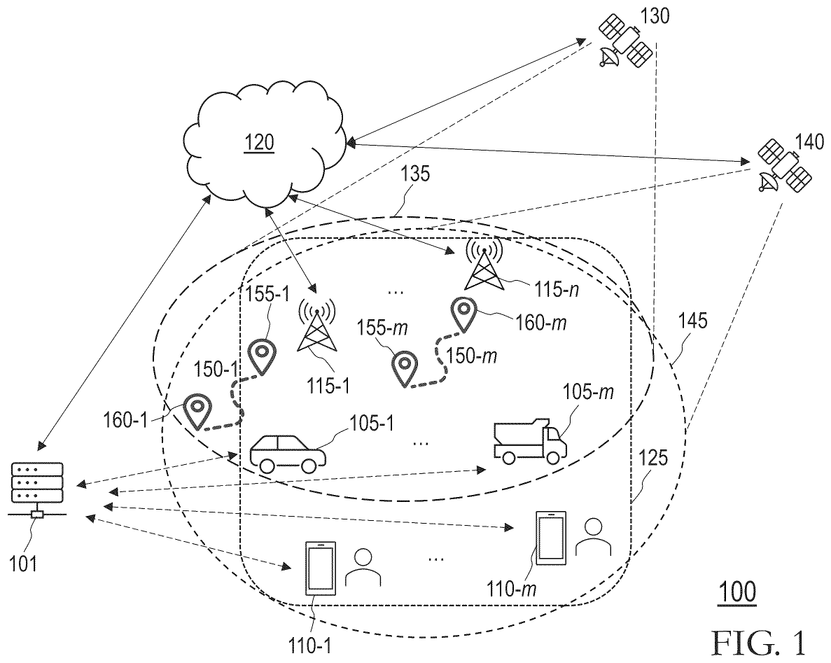

FIG. 1 is a schematic illustration of an automated vehicle journey tracking and management system 100 according to one or more exemplary implementations of the present disclosure.

As illustrated in FIG. 1, system 100 is implemented using one or more computing apparatuses 101 that are communicatively coupled to one or more vehicles 105-1 . . . 105-m (m≥1) that are assigned to respective one or more operators of the vehicle(s). In one or more exemplary implementations, the operator(s) of the vehicle are also provided with respective one or more computing devices 110-1 . . . 110-m. In certain embodiments, different numbers of vehicles 105 and computing devices 110 can be in communication with computing apparatus(es) 101. As an example, a smaller number of vehicles 105 can be assigned on an as needed basis to a larger number of operators that were each assigned a computing device 110. According to one or more exemplary implementations, vehicle(s) 105 and computing device(s) 110 are communicatively coupled to computing apparatus(es) 101 via one or more communication access networks (ANs) 115-1 . . . 115-n (n≥1) and one or more networks 120. In certain embodiments, ANs 115 are implemented using cellular and/or radio access networks with respective coverage areas, such as 6G, 5G, 4G, 3G, WiMAX, WiFi, to name a few. For illustrative purposes, FIG. 1 shows coverage area 125 provided by AN(s) 115 but coverage area 125 can be provided using one or more networks (e.g., terrestrial networks) conforming to various standards and protocols as understood by those of ordinary skill in the art. According to one or more exemplary implementations, the services provided in coverage area 125 include location-based services including, but not limited to, terrestrial network-based positioning and navigation. In certain embodiments, computing apparatus(es) 101 is part of and network(s) 120 can include one or more secure, private, enterprise networks comprised of switches (not shown), routers (not shown), and other computing devices (not shown) for facilitating communications and data exchanges among servers, such as computing apparatus(es) 101 and information systems (not shown), and clients, such as vehicle(s) 105 and computing device(s) 110, while conforming to various connections and protocols as understood by those of ordinary skill in the art. Network(s) 120 can be accessed, for example, using Transfer Control Protocol and Internet Protocol (“TCP/IP”) (e.g., any of the protocols used in each of the TCP/IP layers) and suitable application layer protocols and can include elements of a public network, such as the Internet. In certain embodiments, clients, such as computing device(s) 110, can communicate with computing apparatus(es) 101 via a virtual private network (“VPN”) tunnel through, for example, network(s) 120. Such tunnels can employ Layer 2 Tunneling Protocol (L2TP) and the like.

As further illustrated in FIG. 1, vehicle(s) 105 is communicatively coupled to a satellite-based global positioning system (GPS) 130. For illustrative purposes, GPS 130 is shown to provide location services for vehicle(s) 105 over a coverage area 135. In certain embodiments, coverage area 135 can span extended and remote regions that have line of sight (LOS) to satellites of system 130. Correspondingly, computing device(s) 110 is communicatively coupled to a satellite-based global position system (GPS) 140. For illustrative purposes, GPS 140 is shown to provide location services for computing device(s) 110 over a coverage area 145. In certain embodiments, coverage area 145 can span extended and remote regions that have line of sight (LOS) to satellites of system 140. In some embodiments, GPS 130 and 140 can be an integrated system and, in other embodiments, GPS 130 and 140 can be independent systems with respective protocols and/or dedicated to locating respective kinds of devices. For example, computing device(s) 110 and/or vehicle(s) 105 can be adapted to communicate via satellite-based communication systems.

Accordingly, system 100 incorporates triplex layered geofencing, e.g., coverage areas 125, 135, and 145, for tracking the location of each vehicle 105 and/or a corresponding computing device 110 assigned to an associated person that is also assigned to the vehicle 105. The redundancy provided by system 100 not only improves reliability of mobile connectivity but also ensures more accurate and timely location of each vehicle 105 and its assigned user. In some embodiments, the triplex layered geofencing, and the networks and systems for providing coverage areas 125, 135, and 145, can be partially or fully integrated. As a safety enforcement mechanism, in certain embodiments, system 100 detects any moving vehicle 105 and automatically cross checks with an assigned and initiated journey for the detected vehicle 105. If there is no associated journey, for example, a trip number, assigned to the moving vehicle, system 100 triggers an immediate alert to one or more persons assigned to the vehicle 105 that is in violation, such as the vehicle owner and a direct supervisor.

According to one or more exemplary implementations, system 100 executed using one or more computing apparatuses 101 provides a graphical user interface (GUI) to computing device(s) 110 and/or vehicle(s) 105 for planning, approving, and initiating journeys for vehicle(s) 105 and corresponding driver(s). FIG. 1 illustrates journeys 150-1 and 150-m (m≥1) that have been assigned to vehicles 105-1 and 105-m, respectively. As illustrated in FIG. 1, each journey 150 includes at least a start point 155 (155-1 . . . 155-m) and one or more end points (checkpoints or destinations) (160-1 . . . 160-m). Upon initiating such a pre-planned journey 150, system 100 automatically tracks the progress of the vehicle 105 against its approved journey 150. In one or more exemplary embodiments, system 100 periodically updates the status of the vehicle 105 against its approved pre-planned journey 150. If there are any time and/or location-based deviations, system 100 initiates contact to the driver via communications to vehicle 105 and/or computing device 110. The driver can then either request assistance or provide an update on the journey 150. For example, the driver can provide an updated estimated time of arrival (ETA), add one or more intermediate points (not shown) between start point 155 and end point(s) 160, or the like. System 100 automatically escalates an alert to one or more operators, for example, up a hierarchy of supervisors of the driver, if a response is not received from the driver within a predetermined period, for example, one (1) hour. After a predetermined number of nonresponsive periods and alert escalations, for example, three (3), system 100 transmits an emergency assistance request, for example, to an emergency service. In one or more exemplary embodiments, the emergency assistance request incorporates up-to-the-moment, real time, or near real time, location information of the vehicle 105 and/or computing device 110 obtained via the triplex layered geofencing, for example, cellular location services via AN(s) 115 in area 125, GPS 130 in area 135, and/or GPS 140 in area 145. In certain embodiments, system 100 can also incorporate additional mechanisms other than timing and predefined routes for triggering an immediate determination of the location of a driver (e.g., computing device 110) and/or a vehicle 105 via the triplex layered geofencing. As an example, system 100 can be communicatively coupled to one or more operational subsystems of vehicle(s) 105 and a critical malfunction, or damage (e.g., from a vehicular accident), detected at vehicle(s) 105 can be automatically communicated from vehicle(s) 105 to trigger an alert, as well as a request transmission to an emergency service.

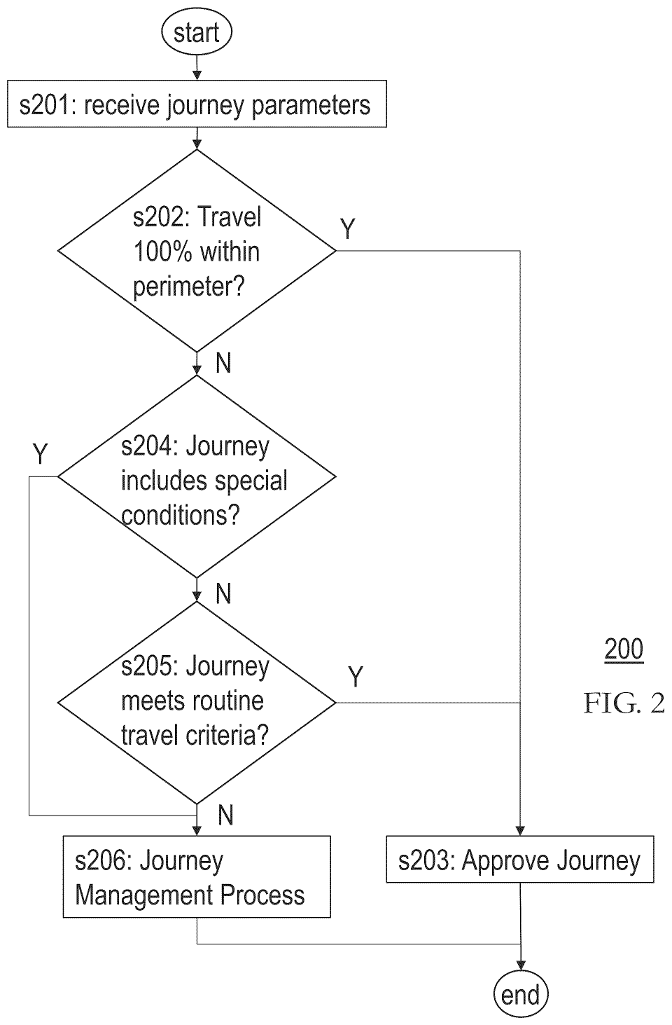

FIG. 2 is a flow diagram showing a vehicle journey planning and approval process 200 executed using system 100 according to one or more exemplary implementations of the present disclosure. Process 200 includes steps for making determinations associated with one or more conditions, where system 100 is configured to respond to the one or more conditions using programmed hardware as can be understood by one of ordinary skill in the art.

As illustrated in FIG. 2, process 200 initiates at step s201, where computing apparatus(es) 101 receives journey parameters from a user for pre-planning and approval. According to one or more exemplary implementations, such parameters are input by the user at computing device 110 using a GUI and transmitted to computing apparatus(es) 101 via network 120. In certain embodiments, the parameters can be input using a GUI at a display screen in vehicle 105.

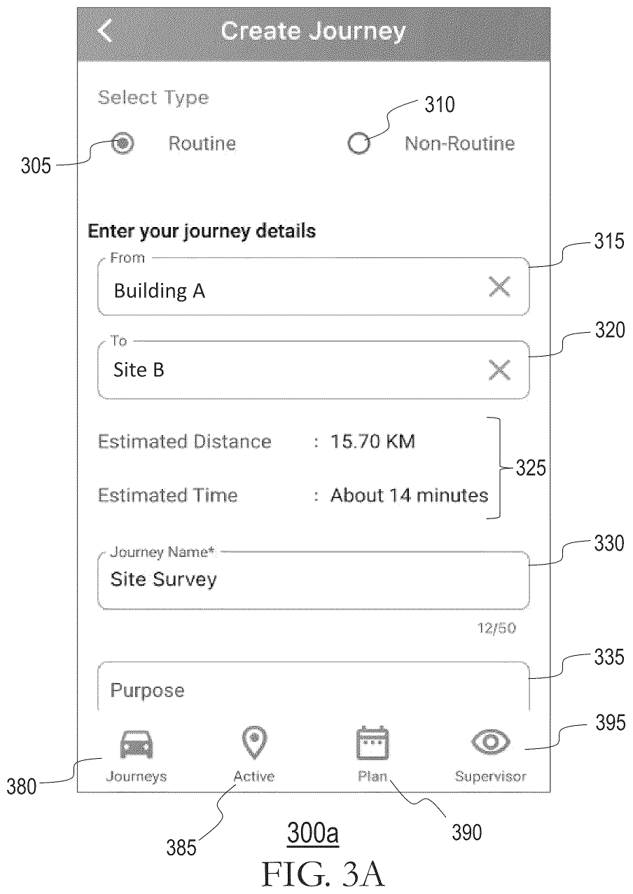

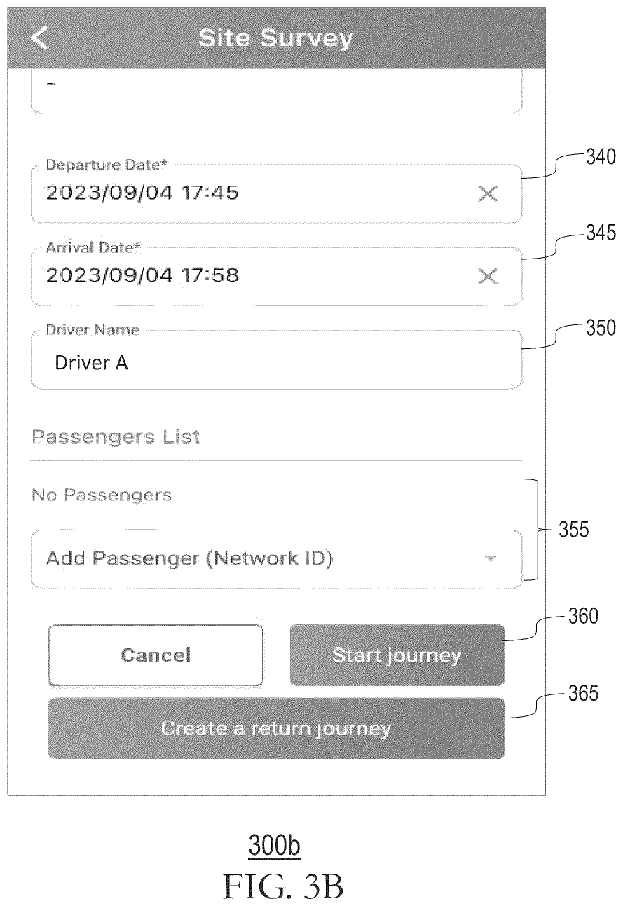

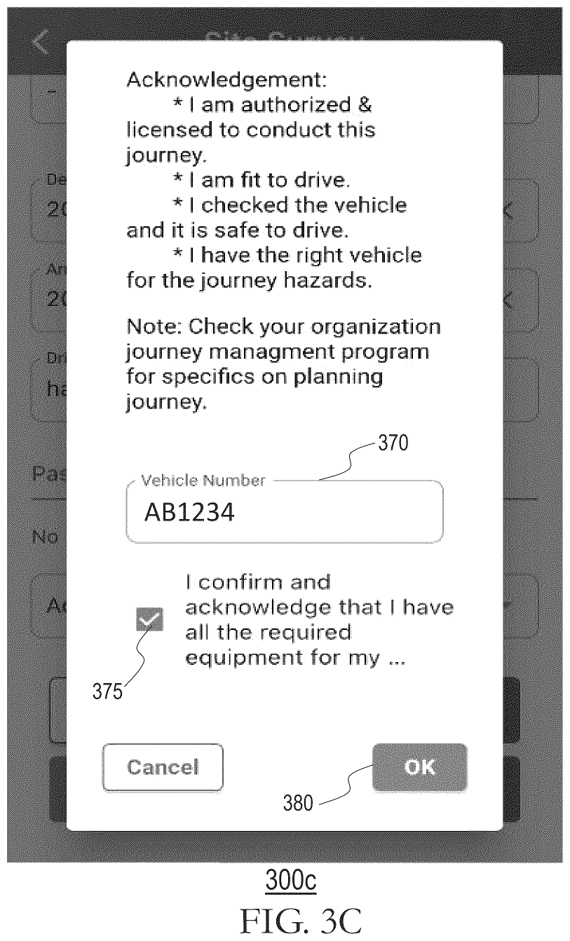

FIGS. 3A-3C are diagrams illustrating GUI screens 300a-300c, respectively, for inputting journey parameters to be transmitted to computing apparatus(es) 101 in correspondence with step s201 of process 200 according to one or more exemplary implementations of the present disclosure. GUI screens 300a-300c can be rendered at computing device 110 upon the user executing a journey planning application. In certain embodiments, the journey planning application can incorporate an interface to a network site that is maintained via network 120 and/or computing apparatus(es) 101. In other embodiments, the network site can be accessed using a network communication application, such as an Internet browser or the like.

Upon the user executing the journey planning application at computing device 110 (or at a display console in vehicle 105 incorporating a computer processing device (not shown)), GUI screen 300a is rendered on a display screen of computing device 110 for inputting journey parameters for pre-planning and approval. As illustrated in FIG. 3A, GUI screen includes at least two selection options: a first selection option 305 for “Routine” travel and a second selection option 310 for “Non-Routine” travel. The selection between these options define whether the planned journey is considered routine by the driver and can form at least a partial basis for system 100 to determine whether the journey is routine, which might not require journey management and tracking, or non-routine, which might require journey management and tracking.

As illustrated in FIG. 3A, GUI screen 300a includes fields for entering a “From” starting point 315 (e.g., “Building A”) and a “To” destination 320 (e.g., “Site B”) of a planned journey. In one or more exemplary implementations, destination 320 is input using a selection menu with pre-approved destinations. As an example, an organization can preset approved remote locations as travel destinations for certain work vehicles and corresponding drivers. In certain embodiments, drivers can be provided with a search function, including a map, for setting a journey destination. In some embodiments, the “From” starting point 315 is entered based on a detected location of computing device 110 or vehicle 105.

In one or more exemplary embodiments of the present disclosure, the journey planning application includes functionality for calculating and outputting an estimated travel distance (e.g., “15.70 KM”) and an estimated travel time (e.g., “About 14 minutes”) for the entered end points in fields 315 and 320 of the planned journey, as illustrated by the output fields 325 in FIG. 3A. A “Journey Name” field 330 is provided for identifying the planned journey (e.g., “Site Survey”) and a “Purpose” field 335 is provided for entering and defining a purpose of the planned journey.

FIG. 3B illustrates GUI screen 300b, which is a downward scroll continuation from of GUI screen 300a. As shown in FIG. 3B, GUI screen 300b includes fields for “Departure Date” 340 (e.g., “2023/09/04 17:45”), “Arrival Date” 345 (e.g., “2023/09/04 17:58”), “Driver Name” 350 (e.g., “Driver A”), and “Passengers List” 355. In one or more exemplary implementations, “Arrival Date” 345 is automatically generated upon a user's entry of the “Departure Date” 340 based on an estimated travel time, as displayed in output fields 325 shown in FIG. 3A. In certain embodiments, the user is enabled to enter an “Arrival Date” 345 that extends the estimated travel time within a threshold range to provide for rest stops, refuels, or the like. Such extensions can also be automatically calculated based on road conditions, traffic, time of day, total travel time, to name a few. In some embodiments, the departure date 340 and/or arrival date 345 are entered using a selection menu (not shown), which can include a calendar, a clock, and/or a scrolling menu.

In certain embodiments, the driver identification entered in field 350 can be used to retrieve contact information and assigned vehicle information for journey management and tracking, including emergency service communications. Likewise, the passenger identification information entered in field 355 can be used to retrieve contact information for journey management and tracking. In some embodiments, GUI screen 300b can include a field for entering a telephone number, for example, of the computing device 110 of the driver and/or an onboard telephone of the vehicle 105 assigned to the driver (see field 370 in FIG. 3C) as an alternative means for contacting the driver in case of an emergency.

As further shown in FIG. 3B, GUI screen 300b includes a “Start Journey” button 360 and a “Create a return journey” button 365. The “Start Journey” button 360 functions transmit the parameters of the planned journey that are entered and generated at GUI screens 300a and 300b for transmission to computing apparatus(es) 101 in correspondence with step s201 of process 200. The “Create a return journey” button 365 functions to provide the user with an interface for creating a return journey from a destination to a starting point of a first journey, for example, by reversing fields 315 and 320. In certain embodiments, the interface for creating the return journey corresponds to GUI screens 300a and 300b but with the contents of fields 315 and 320 being reversed.

In certain embodiments, the computing device 110 can be provided with additional features for the user to search for locations to be set in fields 315 and 320. In some embodiments, GUI screen 300a can further incorporate an addition toggle (not shown) for inputting additional destinations and/or checkpoints for a journey. Additionally, an entered journey can be displayed on a map with a starting point corresponding to field 315 and a destination corresponding to field 320, with selectable routes and respective estimated travel times also displayed for the user's selection.

Once all of the fields in GUI screens 300a and 300b for a planned journey have been entered, the user can submit the planned journey for approval by toggling the “Start Journey” button 360 on GUI screen 300b.

FIG. 3C illustrates GUI screen 300c that is displayed upon the user toggling the “Start Journey” button 360 on GUI screen 300b. As shown in FIG. 3C, GUI screen 300c includes a display of reminders for a driver's acknowledgement, including: the driver is authorized and licensed to conduct the entered journey; the driver is fit to drive; the driver has checked the vehicle and confirmed that it is safe to drive; that the driver has confirmed that a suitable vehicle has been selected for the journey hazards. Additionally, GUI screen 300c includes a field 370 for entering a “Vehicle Number” (or identifier) that identifies a vehicle 105 (e.g., “AB1234”) requested by the user or assigned to the user. In certain embodiments, field 370 can incorporate a search function for vehicles, and/or their respective identifiers, that are available to the user and that are suitable for the planned journey. The journey planning application can incorporate features for verifying availability and suitability of the vehicle number entered in field 370.

As shown in FIG. 3C, GUI screen 300c also includes a checkbox 375 for confirming that the driver acknowledges having the required equipment for the planned journey. In certain embodiments, the checkbox can incorporate an additional user interface for a checklist of equipment needed for a planned journey. For example, a checklist can be provided for safety equipment, such as communication device (e.g., computing device 110), two spare tires, fire extinguisher, and winch or cable, as well as personal equipment, such as first aid kit, drinking water (e.g., 15 Liters), area maps, spare food (e.g., for 3 days), desert driving handbook, search & rescue bag, compass and GPS navigator, and sun screen (optional), to name a few.

With the vehicle number entered in field 370 and the confirmation checkbox 375 checked, the user can submit the planned journey for approval and initiate the journey by toggling the “OK” button 380. With the “OK” button 380 being toggled, the journey parameters that are entered in the fields of GUI screens 300a-300c are transmitted to computing apparatus(es) 101 and received at step s201 of process 200. In certain embodiments, the journey parameters can include a route selected by the user for the planned journey, and corresponding estimated travel distance and time for the selected route, at the planned departure time according to fields 325 and 340.

Referring back to FIG. 3A, GUI screen 300a includes general navigation links for “Journeys” 385, “Active” 390, “Plan” 395, and “Supervisor” 397. In one or more exemplary implementations, the “Journeys” link 385 directs the user to one or more interfaces with information on all journeys that are submitted using GUI screens 300a-300c and that have not initiated or been approved yet. Such journeys can include, for example, approved journeys for which the planned start date has not arrived yet and journeys that are pending approval by a supervisor. In certain embodiments, the interface(s) for the “Journeys” link 385 can include GUI screens 300a-300c for modifying a previously submitted journey or creating a return journey via button 365. The “Active” link 390 directs the user to one or more interfaces for an active journey that is ongoing, which is described in further detail below. The “Plan” link 395 directs the user to GUI screens 300a-300c for planning and submitting a new journey. The “Supervisor” link 397 directs the appropriate supervisory user to one or more interfaces for approving submitted journeys and for receiving alerts regarding active and ongoing journeys. In certain embodiments, the “Supervisor” link 397 can direct a user to a portal for communications with a supervisor, for example, for any comments regarding an approval for a submitted journey.

Returning to process 200 and referring back to FIG. 2, upon receiving the journey parameters from a user, computing apparatus(es) 101 proceeds to step s202, where it determines whether the planned journey would include travel that is completely within a predetermined perimeter. In one or more exemplary implementations, the predetermined perimeter is set according to proximity and/or safety considerations. For example, the perimeter can be a municipal boundary, a private property boundary, or the like.

At step s202, if computing apparatus(es) 101 determines that the planned journey received at step s201 includes travel that is completely (100%) within a perimeter (“Y”), process 200 proceeds to step s203, where computing apparatus(es) 101 approves the journey. In one or more exemplary embodiments, the journey is approved without the need for journey tracking by system 100, or computing apparatus(es) 101. In certain embodiments, computing apparatus(es) 101 transmits an approval message to the computing device 110 of the user and a “trip” is added to section 380 in GUI screen 300e shown in FIG. 3E when the user navigates to GUI screen 300e. In some embodiments, computing apparatus(es) 101 activates the vehicle 105 that is assigned to the user who submitted the planned journey. Additionally, a supervisory approval can be sidestepped at step s203. In other embodiments, computing apparatus(es) 101 can transmit a notification to a computing device 110 associated with a supervisor for finalizing an approval of a journey at step s203.

At step s202, if computing apparatus(es) 101 determines that the planned journey received at step s201 includes travel that is not completely within the perimeter (“N”), process 200 proceeds to step s204, where computing apparatus(es) 101 determines whether the planned journey would include special conditions. In one or more exemplary implementations, the special conditions include nighttime driving (for example, between 6 pm and 6 am), travel and activity that exceeds 24 hours, travel that crosses a national border, travel outside of safe zones, travel off road, travel in an area lacking terrestrial network coverage, to name a few. In certain embodiments, a special condition can include a journey that traverses outside one or more of coverage areas 125, 135, and 145 of the triplex layered geofencing. As an example, with reference to FIG. 1, end point 160-1 is located outside of coverage area 125. Accordingly, journey 150-1 can be determined by system 100 to include a special condition. In one or more exemplary embodiments, the special conditions are determined by system 100 based on data from location maps, seasonal data on sunrise and sunset times, data from current event sources, coverage information and status data from various networks, to name a few. Accordingly, as an example, the requisite data can be retrieved at computing apparatus(es) 101 via network 120.

At step s204, if computing apparatus(es) 101 determines that the planned journey would not include any special conditions (“N”), process 200 proceeds to step s205, where computing apparatus(es) 101 determines whether the planned journey meets predetermined criteria for routine travel.

At step s204, if computing apparatus(es) 101 determines that the planned journey would include one or more special conditions (“Y”), process 200 proceeds to step s206, where computing apparatus(es) 101 approves the planned journey and activates a journey management and tracking process for monitoring the approved journey.

Next, at step s205, computing apparatus(es) 101 determines whether the planned journey meets predetermined criteria for routine travel. According to one or more exemplary implementations, routine travel is determined based at least in part on the user selection of the “Routine” travel option 305 in GUI screen 300a shown in FIG. 3A. In certain embodiments, computing apparatus(es) 101 can take into account additional criteria for routine travel, which can include whether the journey is a periodically repeated journey along a known route, whether the journey is less than a travel distance threshold (for example, about 1 to about 150 kilometers (km)), whether the journey is within an expanded perimeter (for example, within about 1 to about 15 km of a center point), whether the estimate travel time is less than a travel time threshold (for example, 0 to about 2 hours), whether the journey is between known sites, to name a few. For example, routine journeys can be repeated daily, weekly, biweekly, or the like. In some embodiments, routine travel journeys can be predefined based on starting point, destination, and/or routing. Accordingly, a planned journey can be matched against such predefined routine travel journeys at computing apparatus(es) 101. If computing apparatus(es) 101 determines that the planned journey meets predetermined criteria for routine travel (“Y”), process 200 proceeds to step s203.

At step s205, if computing apparatus(es) 101 determines that the planned journey does not meet criteria for routine travel (“N”), process 200 proceeds to step s206.

At step s206, computing apparatus(es) 101 approves the planned journey and activates a journey management and tracking process for monitoring the approved journey. In certain embodiments, step s206 can include computing apparatus(es) 101 transmitting a notification to a computing device 110 associated with a supervisor of the user who submitted the planned journey. Accordingly, a planned journey that includes at least one special condition, for example, can require an approval by a supervisor at step s206.

Once a journey has been approved and the departure date/time has arrived, the journey becomes active and can be accessed, for example, by the user at computing device 110 by following the “Active” link 385 in GUI screen 300a shown in FIG. 3A.

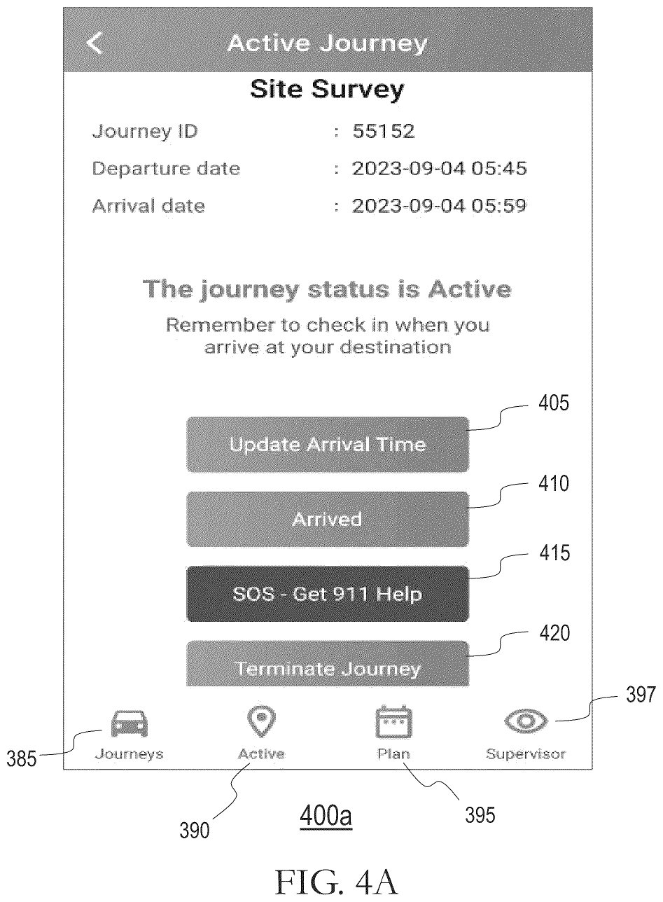

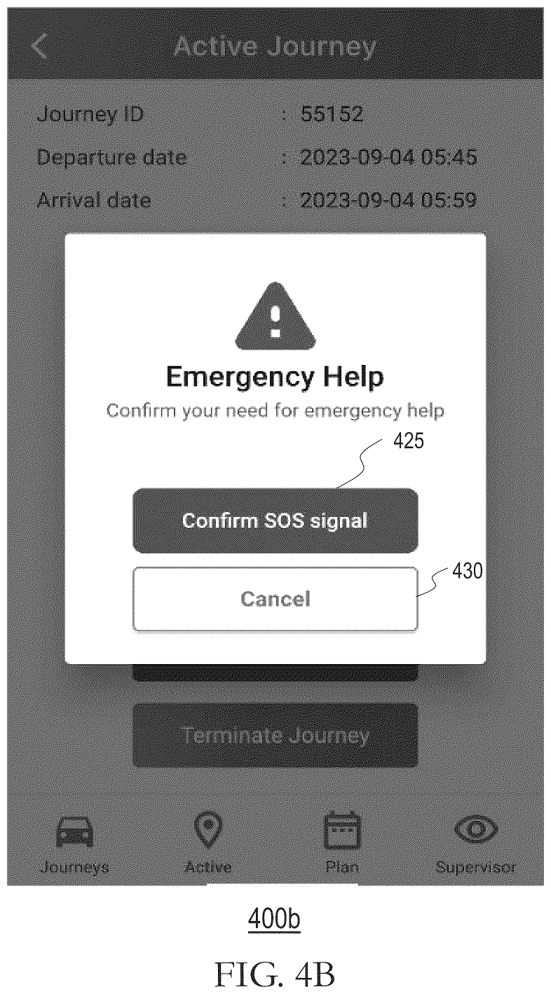

FIGS. 4A and 4B are diagrams illustrating GUI screens 400a and 400b, respectively, for functionality at vehicle 105 and/or computing device 110 for an active journey according to one or more exemplary implementations of the present disclosure. FIG. 4A is a diagram illustrating a GUI screen 400 for an active journey according to one or more exemplary implementations of the present disclosure.

As shown in FIG. 4A, GUI screen 400 includes a display of the name for the journey (e.g., “Site Survey”), the “Departure date” for the journey (e.g., “2023-09-04 05:45”), and the expected “Arrival date” for the journey (e.g., “2023-09-04 05:59”). Additionally, GUI screen 400 includes an “Update Arrival Time” button 405, an “Arrived” button 410, an “SOS—Get 911 Help” button 415, and a “Terminate Journey”button 420.

The “Update Arrival Time” button 405 provides the user with the capability to update the estimated arrival time for an active journey, for example, in the event of a minor delay, traffic, or the like. In certain embodiments, the user can be directed to a GUI screen (not shown) with a selection menu (not shown), which can include a calendar, a clock, and/or a scrolling menu, for entering the updated arrival time.

The “Arrived” button 410 provides for the user to confirm an arrival to a pre-planned destination. In certain embodiments, button 410 can be restricted from selection until vehicle 105 and/or computing device 110 of a user is detected to be within a proximity perimeter of a destination of an approved and initiated journey.

The “SOS—Get 911 Help” button 415 provides the user with the capability to contact emergency services in the event of an emergency. Advantageously, button 415 of GUI screen 400 provides a user with a straightforward interface for contacting emergency services that would not require prolonged attention from the user in the event it needs to be toggled while the user is operating vehicle 105. FIG. 4B illustrates GUI screen 400b for confirming an emergency request initiated by toggling button 415. As illustrated in FIG. 4B, GUI screen 400b includes a confirmation (“Confirm SOS signal”) button 425 and a cancellation (“Cancel”) button 430. The user can confirm a request for emergency services by toggling button 425 or cancel the operation without making a request by toggling button 430. In one or more exemplary embodiments, a concurrent alert is issued by system 100 to one or more operators and/or supervisors associated with the journey, for example, to the computing device(s) 110 of the operator(s) and/or supervisor(s), upon the user confirming a request for emergency services.

Referring back to FIG. 4A, the “Terminate Journey” button 420 provides for canceling and terminating an active journey. In certain embodiments, a notification is transmitted to supervisor upon an active journey being canceled. In some embodiments, a supervisor confirmation can be required for a journey to be canceled.

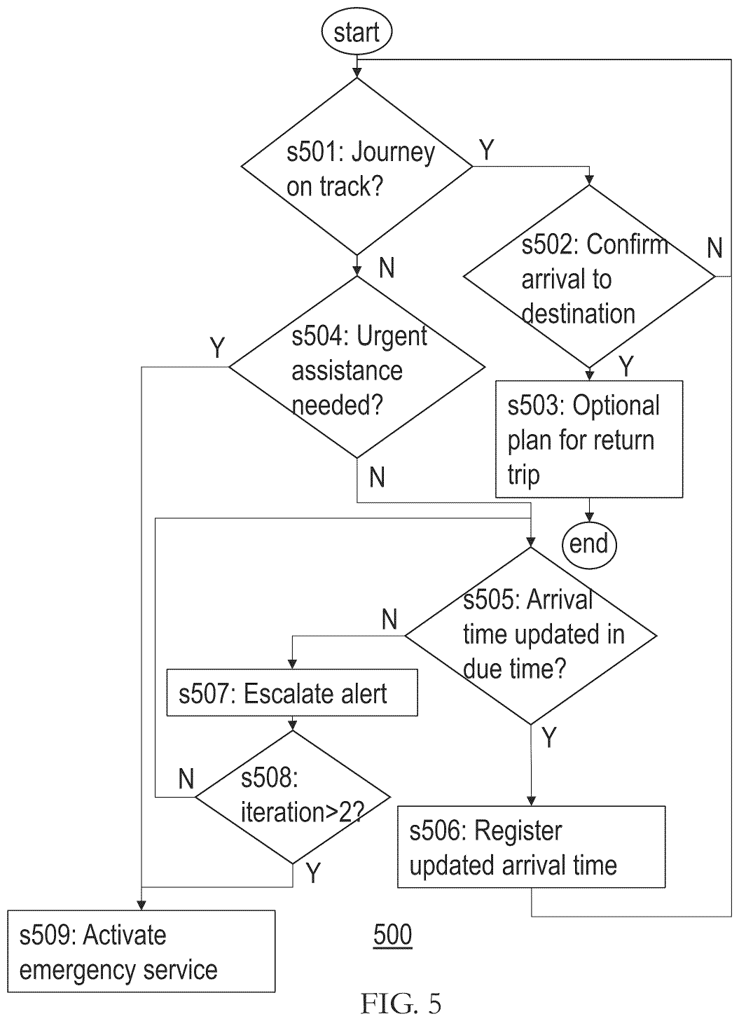

FIG. 5 is a flow diagram showing an active journey management and tracking process 500 executed using system 100 according to one or more exemplary implementations of the present disclosure. Process 500 includes steps for making determinations associated with one or more conditions, where system 100 is configured to respond to the one or more conditions using programmed hardware as can be understood by one of ordinary skill in the art.

As illustrated in FIG. 5, process 500 initiates with step s501, where system 100 monitors vehicle 105 and/or computing device 110 associated with an active journey to determine whether the active journey is on track and progressing according to plan. In one or more exemplary embodiments, an application at computing apparatus(es) 101 is executed to monitor the location of the vehicle 105 and/or computing device 110 and to compare one or more obtained locations of the vehicle 105 and/or computing device 110 against an expected location based on the expected progress of an active journey. In certain embodiments, application(s) executed at the vehicle 105 and/or computing device 110, for example, the application associated with GUI screen 400, can incorporate journey progress tracking features. Accordingly, one or more locations determined using location services provided in coverage areas 125, 135, and 145 can be transmitted to computing apparatus(es) 101 for comparison against an expected location for the active journey. In some embodiments, step s501 is performed iteratively or recursively until the vehicle 105 and/or computing device 110 arrives at the destination of an active journey.

When system 100 determines that the active journey is on track (“Y”), process 500 proceeds to step s502, where system 100 determines whether a user of an active journey has confirmed arrival at a destination of the active journey. In accordance with one or more exemplary implementations, the confirmation is associated with the user toggling the “Arrived” button in GUI screen 400 when the vehicle 105 and/or computing device 110 of the user is within a proximity perimeter (e.g., 0 to about 0.1 km) of the destination of the active journey. In some embodiments, a confirmation message is transmitted from the vehicle 105 and/or computing device 110 of the user to computing apparatus(es) 101 via network 120. According to one or more exemplary implementations, steps s501 and s502 are performed iteratively or recursively so that when system 100 determines that a destination confirmation has not been received from the user of the active journey (“N”), process 500 returns to step s501.

When system 100 determines that a user has confirmed arrival at a destination (“Y”), process 500 concludes with step s503 of an option for planning a return trip. In one or more exemplary implementations, a user is provided with a link (not shown) to GUI screens 300a and 300b for planning a return journey when the user confirms arrival by toggling “Arrived” button 410 in GUI screen 400. In certain embodiments, the starting point, destination, and driver name (e.g., fields 315, 320, and 350 in FIGS. 3A and 3B) can be pre-populated for the return journey planning. In some embodiments, the link to the return journey planning can correspond to the “Create a return journey” button 365 in GUI screen 300b shown in FIG. 3B.

Returning to FIG. 5, when system 100 determines that an active journey is not on track (“N”), process 500 proceeds to step s504, where system 100 determines whether the user of the active journey requires urgent assistance. In one or more exemplary implementations, when system 100 determines that the vehicle 105 and/or computing device 110 associated with the active journey is not within a proximity perimeter (for example, about 1 km to about 2 km) of an expected progress point of the active journey, a notification is transmitted to the vehicle 105 and/or computing device 110 for soliciting a status response from the user. As an example, a notification with links associated with the “Update Arrival Time” button 405 and the “SOS—Get 911 Help” button 415 in GUI screen 400, as shown in FIG. 4, is triggered to be rendered on the display of the vehicle 105 and/or computing device 110 when it is determined that the location of the vehicle 105 and/or computing device 110 exceeds a predetermined distance from an expected location based on the expected progress of the active journey. In some embodiments, a triggering message for the notification is transmitted from computing apparatus(es) 101, via network 120, to the vehicle 105 and/or computing device 110 associated with the active journey that is determined not to be on track.

In one or more exemplary embodiments, the monitoring of an active journey that has been determined not to be on track includes an iterative or recursive process of detecting for status updates from the user associated with the active journey. When system 100 does not detect a request for urgent assistance at step s504 (“N”), process 500 proceeds to step s505, where system 100 determines whether the user associated with the actual journey has provided an updated arrival time, for example, via button 405 in GUI screen 400. If system 100 determines that an updated arrival time has been entered by the user (“Y”), process 500 proceeds to step s506, where system 100 registers the updated arrival time for the active journey and proceeds back to step s501 to continue tracking the active journey based on the updated arrival time. In one or more exemplary implementations, the updated arrival time is transmitted from the vehicle 105 and/or computing device 110 of the user associated with the active journey to computing apparatus(es) 101 via network 120 for registration and updated tracking.

If system 100 determines that an updated arrival time has not been entered by the user associated with the active journey for a predetermined period of time (“N”), process 500 proceeds to step s507, where an alert is escalated to a next level in a hierarchy of system 100. In one or more exemplary implementations, the predetermined period of time is about one (1) hour. In certain embodiments, the predetermined period of time can be adjusted based upon one or more characteristics of the active journey. For example, the predetermined period of time can be shortened for journeys that traverse more remote or treacherous areas and lengthened for more proximate or shorter journeys. In one or more exemplary embodiments, the hierarchy of system 100 includes a hierarchy of operators and/or supervisors associated with the active journey. Accordingly, system 100 issues a notification to a next supervisor in the hierarchy, e.g., to a computing device 110 associated with the supervisor, regarding the active journey at step s507. Upon completing steps s505 and s507, system 100 increments, or advances, an iteration counter (e.g., iteration counter=iteration counter+1) according to one or more exemplary implementations of the present disclosure.

Next, at step s508, system 100 determines whether the iterative or recursive steps s505 and s507 have exceeded two (2) iterations or recursions (e.g., iteration counter>2). If not (“N”), process 500 returns to step s505, where system 100 determines, again, whether an updated arrival time has been entered by the user associated with the active journey in due time, or within a predetermined period of time. If iterative or recursive steps s505 and s507 have been performed for more than two (2) iterations (“Y”), system 100 proceeds to step s509, where system 100 automatically issues an urgent request to emergency services on behalf of the user associated with the active journey. In some embodiments, an updated prompt can be transmitted to the vehicle 105 and/or computing device 110 of the user at each iteration of step s508 to request a response from the user. Thus, in the event the user is unable to communicate with system 100, system 100 automatically escalates alerts in a stepwise fashion until emergency services are requested upon the user failing to respond to system 100 within a predetermined period of time. With reference to FIG. 1, in one or more exemplary implementations, system 100 includes, in the request to emergency services, all of the latest, up-to-the-moment location information of the vehicle 105 and/or the computing device 110 of the user obtained from the triplex layered geofencing, or via ANs 115 and GPSs 130 and 140. In one or more exemplary embodiments, the request to emergency services is transmitted from one or more of computing apparatus(es) 101, vehicle 105, and computing device 110 via network 120.

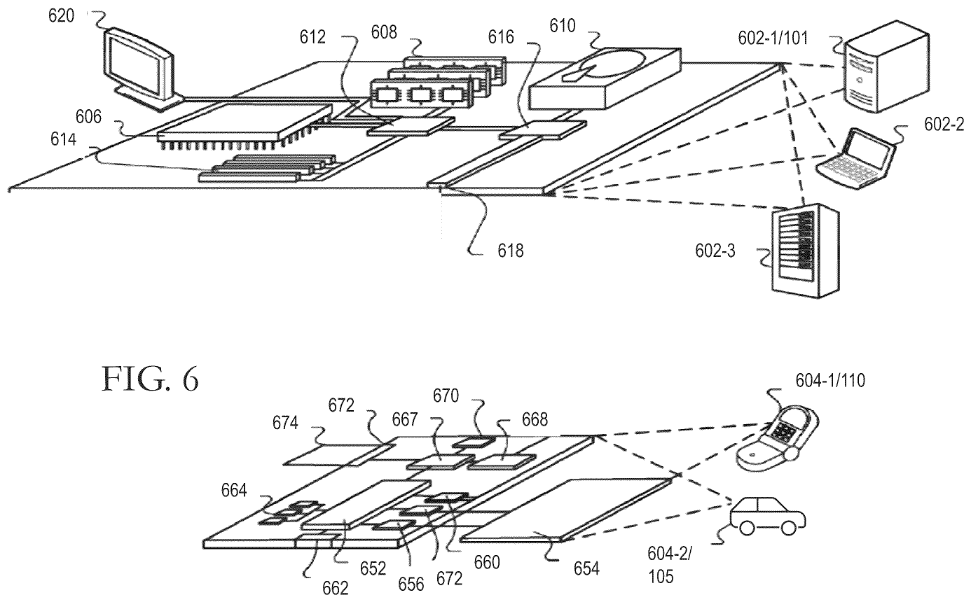

FIG. 6 shows an exemplary computing apparatus 602 and an exemplary mobile computing device 604 that can be used to implement the techniques described herein. Computing apparatus 602 is intended to represent various forms of digital computers, such as desktops (602-1), laptops (602-2), workstations, servers, blade servers, mainframes (602-3), and other appropriate computers. The mobile computing device 604 is intended to represent various forms of mobile devices, such as personal digital assistants, cellular telephones (604-1), smartphones, AR devices, vehicle (105) onboard computing device (604-2) and other similar computing devices. The components shown in FIG. 6, including connections and relationships, and their functions, are meant to be exemplary only, and are not meant to limit implementation of the disclosures described and/or claimed in this document.

The computing apparatus 602 can include a processor 606, a memory 608, a storage device 610, a high-speed interface 612 connecting the memory 608 and multiple high-speed expansion ports 614, and a low-speed interface 616 connecting a low-speed expansion port 618 and the storage device 610. Each of the processor 606, the memory 608, the storage device 610, the high-speed interface 612, the high-speed expansion ports 614, and the low-speed interface 616, are interconnected using various buses, and can be mounted on a common motherboard or in other manners as appropriate. The processor 606 can process instructions for execution within the computing apparatus 602, including instructions stored in the memory 608 or on the storage device 610 to display graphical information for a GUI on an external input/output device, such as a display 620 coupled to the high-speed interface 612. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 608 stores information within the computing apparatus 602. In some implementations, the memory 608 is a volatile memory unit or units. In some implementations, the memory 608 is a non-volatile memory unit or units. The memory 608 can also be another form of computer-readable medium, such as a magnetic or optical disk.

The storage device 610 is capable of providing mass storage for the computing apparatus 602. In some implementations, the storage device 610 can be or contain a computer-readable medium, e.g., a computer-readable storage medium such as a floppy disk device, a hard disk device, an optical disk device, or a tape device, a flash memory or other similar solid-state memory device, or an array of devices, including devices in a storage area network or other configurations. A computer program product can also be tangibly embodied in an information carrier and can contain instructions that, when executed, perform one or more methods, such as those described above. The computer program product can also be tangibly embodied in a computer-or machine-readable medium, such as the memory 608, the storage device 610, or memory on the processor 606.

The high-speed interface 612 can be configured to manage bandwidth-intensive operations, while the low-speed interface 616 can be configured to manage lower bandwidth-intensive operations. Of course, one of ordinary skill in the art will recognize that such allocation of functions is exemplary only. In some implementations, the high-speed interface 612 is coupled to the memory 608, the display 620 (e.g., through a graphics processor or accelerator), and to the high-speed expansion ports 614, which can accept various expansion cards (not shown). In an implementation, the low-speed interface 616 is coupled to the storage device 610 and the low-speed expansion port 618. The low-speed expansion port 618, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter (not shown).

As noted herein, computing apparatus 602 can be implemented in a number of different forms, such as a standard server, or multiple times in a group of such servers. In addition, it can be implemented in a personal computer, such as a desktop computer 602-1 or laptop computer 602-2. It can also be implemented as part of a mainframe computer 602-3 or a rack server system. Alternatively, components from the computing apparatus 602 can be combined with other components in a mobile device, such as a mobile computing device 604. Each of such devices can contain one or more of the computing apparatus 602 and the mobile computing device 604, and an entire system can be made up of multiple computing devices communicating with each other. As an example, such multiple computing devices can be implemented, at least in part, in computing apparatus(es) 101.

The mobile computing device 604 includes a processor 652; a memory 664; an input/output device, such as a display 654; a communication interface 667; and a transceiver 668; among other components. The mobile computing device 604 can also be provided with a storage device, such as a micro-drive or other device, to provide additional storage. Each of the processor 652, the memory 664, the display 654, the communication interface 667, and the transceiver 668, are interconnected using various buses, and several of the components can be mounted on a common motherboard or in other manners as appropriate. In some implementations, the mobile computing device 604 can include a camera device(s). The processor 652 can execute instructions within the mobile computing device 604, including instructions stored in the memory 664. The processor 652 can be implemented as a chipset of chips that include separate and multiple analog and digital processors. For example, the processor 652 can be a System on a Chip (SoC) processor, System In a Package (SIP) processor, an Application-Specific Integrated Circuit (ASIC) processor, a Complex Instruction Set Computer (CISC) processor, a Reduced Instruction Set Computer (RISC) processor, or a Minimal Instruction Set Computer (MISC) processor.

The processor 652 can provide, for example, for coordination of the other components of the mobile computing device 604, such as control of user interface (UI), applications run by the mobile computing device 604, and/or wireless communication by the mobile computing device 604. The processor 652 can communicate with a user through a control interface 658 and a display interface 656 coupled to the display 654. The display 654 can be, for example, a Thin-Film-Transistor Liquid Crystal Display (TFT) display, an Organic Light Emitting Diode (OLED) display, or other appropriate display technology. The display interface 656 can include appropriate circuitry for driving the display 654 to present graphical and other information to a user. The control interface 658 can receive commands from a user and convert them for submission to the processor 652. In addition, an external interface 662 can provide communication with the processor 652, so as to enable near area communication of the mobile computing device 604 with other devices. The external interface 662 can provide, for example, for wired communication in some implementations, or for wireless communication in other implementations, and multiple interfaces can also be used.

The memory 664 stores information within the mobile computing device 604. The memory 664 can be implemented as one or more of a computer-readable medium or media, a volatile memory unit or units, or a non-volatile memory unit or units. An expansion memory 674 can also be provided and connected to the mobile computing device 604 through an expansion interface 672, which can include, for example, a Single in Line Memory Module (SIMM) card interface. The expansion memory 674 can provide extra storage space for the mobile computing device 604, or can also store applications or other information for the mobile computing device 604. Specifically, the expansion memory 674 can include instructions to carry out or supplement the processes described above, and can include secure information also. Thus, for example, the expansion memory 674 can be provided as a security module for the mobile computing device 604, and can be programmed with instructions that permit secure use of the mobile computing device 604.

In addition, secure applications can be provided via the SIMM cards, along with additional information, such as placing identifying information on the SIMM card in a non-hackable manner. The memory can include, for example, flash memory and/or non-volatile random access memory (NVRAM), as discussed below. In some implementations, instructions are stored in an information carrier. The instructions, when executed by one or more processing devices, such as processor 652, perform one or more methods, such as those described above. The instructions can also be stored by one or more storage devices, such as one or more computer-readable or machine-readable mediums, such as the memory 664, the expansion memory 674, or memory on the processor 652. In some implementations, the instructions can be received in a propagated signal, such as, over the transceiver 668 or the external interface 662. The mobile computing device 604 can communicate wirelessly through the communication interface 667, which can include digital signal processing circuitry where necessary. The communication interface 666 can provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS), IP Multimedia Subsystem (IMS) technologies, and 4G and 5G technologies. Such communication can occur, for example, through the transceiver 668 using a radio frequency. In addition, short-range communication, such as using a Bluetooth or Wi-Fi, can occur.

In addition, a Global Positioning System (GPS) receiver module 670 can provide additional navigation-and location-related wireless data to the mobile computing device 604, which can be used as appropriate by applications running on the mobile computing device 604. The mobile computing device 604 can also communicate audibly using an audio codec 660, which can receive spoken information from a user and convert it to usable digital information. The audio codec 660 can likewise generate audible sound for a user, such as through a speaker, e.g., in a handset of the mobile computing device 604. Such sound can include sound from voice telephone calls, can include recorded sound (e.g., voice messages, music files, etc.) and can also include sound generated by applications operating on the mobile computing device 604. The mobile computing device 604 can be implemented in a number of different forms—for example, as shown in FIG. 1, in computing device(s) (or mobile phone(s)) 110 or an onboard vehicle computation system for vehicle(s) 105. Mobile computing device 604 can also be implemented, at least in part, in a tablet device, a laptop computing device, a smartphone, a virtual reality (VR) device, an augmented reality (AR) device, or other similar mobile device. Thus, as an example, a vehicle computation system of a vehicle 105 can comprise mobile computing device 604.

According to one or more exemplary implementations, computing apparatus(es) 101, the vehicle computation system for vehicle(s) 105, and computing device(s) 110 each comprises one or more of computing apparatuses 602 and/or one or more of mobile computing devices 604 for carrying out the above-described features using hardware and/or software components thereof. In some embodiments, one or more computing apparatuses 602 and/or one or more mobile computing devices 604 can be implemented for the computing device(s) 110 of one or more operators and/or supervisors that receive notifications from system 100 regarding a pre-planned journey for approval and/or an active journey. In certain embodiments, elements of network 120 can be implemented, at least in part, with one or more of computing apparatus 602 and/or one or more of mobile computing device 604 using hardware and/or software components thereof. In embodiments, at least a portion of computing apparatus(es) 110 and network 120 can be implemented using a cloud infrastructure, which can comprise multiple computing apparatuses 602 and/or mobile computing devices 604.

Advantageously, the present disclosure provides for:
1. Proactive capability to identify unsafe routes before a journey begins, and for such unsafe routes, a planned journey would include notification(s) to and approval(s) from a driver's management based on the expected risks before the journey is initiated.
2. Automatic classification of a journey to “Non-Routine” requiring preapproval if a journey is initiated at night time, outside of safe zones, off road, or in an area lacking of GSM coverage.
3. Tiered escalation notifications based not only on duration of delay or deviation from geofenced areas but also when communication signals are interrupted between a driver and the system.
4. Automatic notification to a driver upon arrival at a destination to provide positive arrival feedback (e.g., clicking “Arrived” Button 410 of GUI screen 400a) from the driver to confirm safe arrival or a notification to change the expected arrival time in case of any delay.

Portions of the methods described herein can be performed by software or firmware in machine readable form on a tangible (e.g., non-transitory) storage medium. For example, the software or firmware can be in the form of a computer program including computer program code adapted to cause the system to perform various actions described herein when the program is run on a computer or suitable hardware device, and where the computer program can be embodied on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously.

The headings used herein are for organizational purposes only and are not meant to be used to limit the scope of the description or the claims. As used throughout this application, the words “may” and “can” are used in a permissive sense (i.e., meaning having the potential to), rather than the mandatory sense (i.e., meaning must). To facilitate understanding, like reference numerals have been used, where possible, to designate like elements common to the figures. In certain instances, a letter suffix following a dash ( . . . -b) denotes a specific example of an element marked by a particular reference numeral (e.g., 210-b). Description of elements with references to the base reference numerals (e.g., 210) also refer to all specific examples with such letter suffixes (e.g., 210-b), and vice versa.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof, and are meant to encompass the items listed thereafter and equivalents thereof as well as additional items.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting.

While the disclosure has described several example implementations, it will be understood by those skilled in the art that various changes can be made, and equivalents can be substituted for elements thereof, without departing from the spirit and scope of the disclosure. In addition, many modifications will be appreciated by those skilled in the art to adapt a particular instrument, situation, or material to embodiments of the disclosure without departing from the essential scope thereof. Therefore, it is intended that the disclosure not be limited to the particular embodiments disclosed, or to the best mode contemplated for carrying out this disclosure, but that the disclosure will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope encompassed by the present disclosure, which is defined by the set of recitations in the following claims and by structures and functions or steps which are equivalent to these recitations.

What is claimed is:

1. A system, comprising:
one or more processing devices;
a communications interface;
a non-transitory computer-readable memory operatively connected to the one or more processing devices and having stored thereon machine-readable instructions that, when executed, cause the one or more processing devices to:
obtain, via the communications interface from a computing device, a plurality of parameters for a planned journey of a vehicle associated with the computing device;
determine, based on the plurality of parameters, whether the planned journey includes at least one special condition;
in response to determining that the planned journey includes at least one special condition, activate journey monitoring upon initiating the planned journey;
in response to determining that the planned journey does not include at least one special condition, initiate the planned journey without activating the journey monitoring;
wherein the journey monitoring comprises:
obtaining, via the communications interface, a location of the vehicle;
comparing the obtained location of the vehicle to an expected location based on an expected progress of the initiated journey;
in response to the comparing indicating that the obtained location of the vehicle exceeds a predetermined distance from the expected location, determine, in an iterative or recursive manner, whether an updated arrival time has been received from one or more of the computing device and the vehicle via the communications interface, said determination comprising:
in response to determining that the updated arrival time has been received, registering the received updated arrival time in association with the initiated journey and terminating said determining for the updated arrival time;
in response to determining that the updated arrival time has not been received after a predetermined time period, transmitting an alert to another computing device associated with an operator on a next level in a hierarchy associated with the initiated journey; and
incrementing an iteration counter for a next iteration until the iteration counter exceeds a predetermined iteration number; and
in response to the iteration counter exceeding the predetermined iteration number, transmitting a request for emergency services, said request comprising location information from a plurality of sources selected from the group consisting of: a global positioning system (GPS) location associated with the vehicle, a GPS location associated with the computing device, a location associated with the vehicle determined based on one or more terrestrial networks, a location associated with the computing device determined based on one or more terrestrial networks.

2. The system of claim 1, wherein the predetermined distance is about 1 kilometer (km) to about 2 km, the predetermined time period is about 1 hour, and the predetermined iteration number is 2.

3. The system of claim 1, wherein the one or more special conditions are selected from the group consisting of: nighttime driving, travel and activity that exceeds 24 hours, travel that crosses a national border, travel outside of safe zones, travel off road, travel in an area lacking terrestrial network coverage, and travel outside of at least one coverage area of a location determination service.

4. The system of claim 1, further comprising additional machine-readable instructions stored on the non-transitory computer-readable memory that, when executed, cause the one or more processing devices to:
in response to the comparing indicating that the obtained location of the vehicle exceeds a predetermined distance from the expected location and prior to said determining for the updated arrival time, transmit a notification to the computing device, said notification comprising a prompt for a user to request the emergency services.

5. The system of claim 4, wherein the notification further comprises a prompt for a user input for the updated arrival time.

6. The system of claim 1, wherein the journey monitoring further comprises:
determining whether the obtained location of the vehicle is within a predetermined proximity of a destination of the initiated journey,
wherein the journey monitoring is executed in an iterative or recursive manner until the obtained location of the vehicle is determined to be within the predetermined proximity of the destination of the initiated journey, and
wherein the journey monitoring is terminated upon receiving, via the communications interface, an arrival confirmation from at least one of the computing device and the vehicle.

7. The system of claim 6, wherein the journey monitoring further comprises:
receiving, via the communications interface, a communication from a subsystem of the vehicle indicating damage or malfunction in connection with the vehicle,
wherein the transmitting of the alert to another computing device is executed in response to receiving the communication from the subsystem of the vehicle.

8. The system of claim 7, wherein the transmitting of the request for emergency services is executed in response to receiving the communication from the subsystem of the vehicle.

9. The system of claim 1, wherein the parameters comprise a starting point of the planned journey, a destination of the planned journey, a start time of the planned journey, and an identifier for the vehicle.

10. A method, comprising:
obtaining, via a communications interface from a computing device, a plurality of parameters for a planned journey of a vehicle associated with the computing device;
determining, based on the plurality of parameters, whether the planned journey includes at least one special condition;
when it is determined that the planned journey includes at least one special condition, activating journey monitoring upon initiating the planned journey;
when it is determined that the planned journey does not include at least one special condition, initiating the planned journey without activating the journey monitoring;
wherein the journey monitoring comprises:
obtaining, via the communications interface, a location of the vehicle;
comparing the obtained location of the vehicle to an expected location based on an expected progress of the initiated journey;
when the comparing indicates that the obtained location of the vehicle exceeds a predetermined distance from the expected location, determine, in an iterative or recursive manner, whether an updated arrival time has been received from one or more of the computing device and the vehicle via the communications interface, said determination comprising:
when it is determined that the updated arrival time has been received, registering the received updated arrival time in association with the initiated journey and terminating said determining for the updated arrival time;
when it is determined that the updated arrival time has not been received after a predetermined time period, transmitting an alert to another computing device associated with an operator on a next level in a hierarchy associated with the initiated journey; and
incrementing an iteration counter for a next iteration until the iteration counter exceeds a predetermined iteration number; and
when the iteration counter exceeds the predetermined iteration number, transmitting a request for emergency services, said request comprising location information from a plurality of sources selected from the group consisting of: a global positioning system (GPS) location associated with the vehicle, a GPS location associated with the computing device, a location associated with the vehicle determined based on one or more terrestrial networks, a location associated with the computing device determined based on one or more terrestrial networks.

11. The method of claim 10, wherein the predetermined distance is about 1 kilometer (km) to about 2 km, the predetermined time period is about 1 hour, and the predetermined iteration number is 2.

12. The method of claim 10, wherein the one or more special conditions are selected from the group consisting of: nighttime driving, travel and activity that exceeds 24 hours, travel that crosses a national border, travel outside of safe zones, travel off road, travel in an area lacking terrestrial network coverage, and travel outside of at least one coverage area of a location determination service.

13. The method of claim 10, further comprising:
when the comparing indicates that the obtained location of the vehicle exceeds a predetermined distance from the expected location and prior to said determining for the updated arrival time, transmitting a notification to the computing device, said notification comprising a prompt for a user to request the emergency services.

14. The method of claim 13, wherein the notification further comprises a prompt for a user input for the updated arrival time.

15. The method of claim 10, wherein the journey monitoring further comprises:
determining whether the obtained location of the vehicle is within a predetermined proximity of a destination of the initiated journey,
wherein the journey monitoring is executed in an iterative or recursive manner until the obtained location of the vehicle is determined to be within the predetermined proximity of the destination of the initiated journey, and
wherein the journey monitoring is terminated upon receiving, via the communications interface, an arrival confirmation from at least one of the computing device and the vehicle.

16. The method of claim 15, wherein the journey monitoring further comprises:
receiving, via the communications interface, a communication from a subsystem of the vehicle indicating damage or malfunction in connection with the vehicle,
wherein the transmitting of the alert to another computing device is executed in response to receiving the communication from the subsystem of the vehicle.

17. The method of claim 16, wherein the transmitting of the request for emergency services is executed in response to receiving the communication from the subsystem of the vehicle.

18. The method of claim 10, wherein the parameters comprise a starting point of the planned journey, a destination of the planned journey, a start time of the planned journey, and an identifier for the vehicle.
